(19) United States
(12) Patent Application Publication
(10) Pub. No.: US 2014/0378186 A1
(43) Pub. Date: Dec. 25, 2014

(54) COMPOSITE MODULE

(71) Applicant: Murata Manufacturing Co., Ltd., Kyoto (JP)

(72) Inventor: Koji Kawano, Kyoto (JP)

(21) Appl. No.: 14/472,558

(22) Filed: Aug. 29, 2014

Related U.S. Application Data
(63) Continuation of application No. PCT/JP2013/056769, filed on Mar. 12, 2013.

(30) Foreign Application Priority Data
Apr. 10, 2012 (JP) 2012-089229
Jul. 19, 2012 (JP) 2012-160371

(51) Int. Cl. H04M 1/725; H04B 1/38

(52) U.S. Cl. CPC H04M 1/72533; H04B 1/38; H04M 1/7253
USPC 455/557

(57) ABSTRACT

Provided is a composite module that does not put a burden on a host CPU mounted in a host apparatus. A wireless communication module 10 as a composite module according to the present invention is a wireless communication module 10 connected to a host apparatus 30 and configured to control a function of wireless communications with an external terminal of the host apparatus 30. The wireless communication module 10 includes an MCU 12 including a wireless communication control CPU 12a and a wireless communication IC 14, and the wireless communication module 10 further includes a ROM 12b configured to store a wireless communication module driver for installing the wireless communication module 10 on the host apparatus 30. The wireless communication control CPU 12a controls the wireless communication IC 14 and processes the wireless communication module driver.

### BACKGROUND OF THE INVENTION

1. Field of the Invention

The present invention relates to a composite module provided with a wireless communication IC, and specifically, to a wireless communication module, for example.

2. Description of the Related Art

Patent Document 1 discloses a communication system for wireless communications between cellular phones and PCs. A PC in this communication system is provided with a wireless module which is housed or mounted using a communication card or the like in the PC, as a composite module. The wireless module includes a baseband IC, an antenna unit, and the like, and is connected to a PC engine (MPU: micro processing unit) in a PC engine unit, through an interface (serial I/F). In Patent Document 1, the wireless module unit has a function of processing the received data and the data to be transmitted, but the control of the operation of the whole wireless communication is performed by the MPU in the PC engine unit.

Patent Document 1: Japanese Unexamined Patent Application Publication No. 2001-103568

### BRIEF SUMMARY OF THE INVENTION

In the communication system disclosed in Patent Document 1, in the case where a communication system has a large processing capacity, like a PC, or includes a high-speed central processing unit (CPU), it is possible for the host CPU of a PC to take a role of controlling a function for wireless communications, for example, the function of a wireless local area network (LAN). However, in an apparatus, such as a home appliance as a host apparatus or a home appliance whose host CPU has relatively low performance, like a digital camera, when the host CPU takes a role of a portion of the wireless communication function, a portion of the function of the home appliance or the like provided with the host CPU is lost, the processing power of the host CPU for operating the wireless communication module is decreased, resulting in a decrease in throughput. Further, since there is no programs such as drivers for wireless communication originally installed in the host CPU, such as a PC, it is necessary to provide an operation and time for making the CPU load these drivers.

Hence, it is a main object of the present invention to provide a composite module that does not put a burden on a host CPU mounted in a host apparatus.

A composite module according to the present invention is a composite module connected to a host apparatus and configured to control a function of wireless communications between the host apparatus and an external terminal of the host apparatus. The composite module includes: a wireless communication IC; a storage unit connected to the wireless communication IC and configured to store a composite module driver for installing the composite module on the host apparatus; and a wireless communication control CPU connected to the wireless communication IC and configured to control the wireless communication IC and process the composite module driver.

In the composite module according to the present invention, it is preferable that the host apparatus be a home appliance including a host CPU, and the wireless communication control CPU be connected to the host CPU and the home appliance perform a function of wireless communications with an external terminal.

It is preferable that the composite module according to the present invention further include a temperature detection circuit, and the temperature detection circuit be connected to the wireless communication control CPU.

In the composite module according to the present invention, it is preferable that the host apparatus include a power supply, and the composite module further include a DC/DC converter connected to the power supply by connecting the composite module to the host apparatus.

Since the composite module according to the present invention includes a wireless communication control CPU and the wireless communication control CPU controls a wireless communication IC, the processing of the wireless communications can be performed without putting a burden on the host CPU of a host apparatus to which the composite module is connected. Further, since a composite module driver is already installed in the composite module according to the present invention, it is not necessary to separately load a composite module driver in the host apparatus.

Further, by connecting the composite module according to the present invention to a home appliance, the home appliance can easily be made to perform the function of wireless communications with an external terminal.

Further, since the composite module according to the present invention includes a temperature detection circuit, the operation of the composite module can be controlled in accordance with the amount of the heat generated by the composite module.

Further, since the composite module according to the present invention includes a DC/DC converter that allows a power supply voltage required in the composite module to be generated from the power supplied by the host apparatus, there is no need to provide a power supply dedicated to the composite module, resulting in a reduction in size.

According to the present invention, a composite module that does not put a burden on a host CPU mounted in a host apparatus can be provided.

The above-described objects, other objects, features, and advantages of the present invention will be further clarified by the following description of the embodiments of the present invention with reference to the attached drawings.

### BRIEF DESCRIPTION OF THE SEVERAL VIEWS OF THE DRAWINGS

FIG. 1 is a schematic block diagram of a first embodiment of a wireless communication module according to the present invention.

FIG. 2 is a schematic configuration diagram of a home network system using the wireless communication module according to the present invention.

FIG. 3 is a schematic diagram of a second embodiment of the wireless communication module according to the present invention.

FIG. 4 is a schematic diagram of a third embodiment of the wireless communication module according to the present invention.

### DETAILED DESCRIPTION OF THE INVENTION

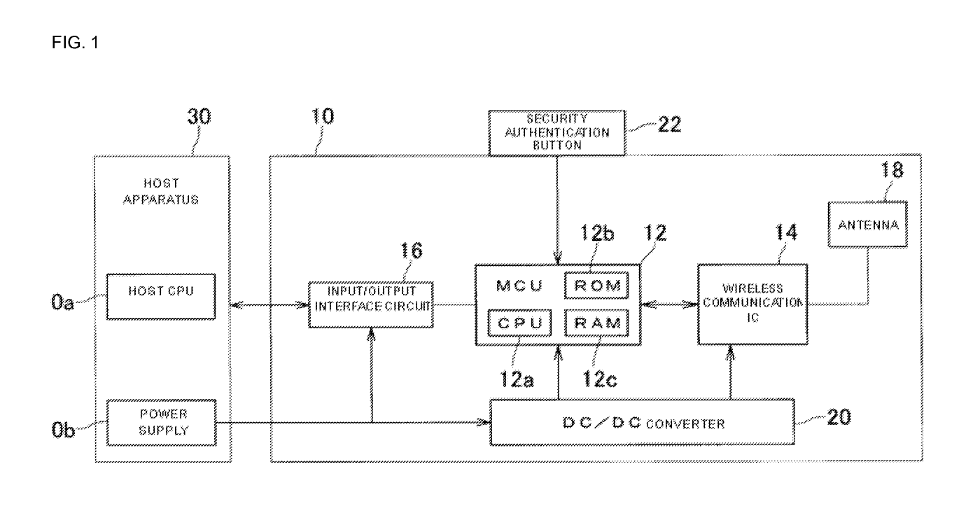

An exemplary embodiment of a wireless communication module as a composite module according to the present invention will be described. FIG. 1 is a schematic block diagram of a first embodiment of the wireless communication module according to the present invention. A wireless communication module 10 is a module which allows a host apparatus 30 to perform a wireless communication function by connecting it to the host apparatus 30. The wireless communication module 10 includes a micro control unit (MCU) 12 and a wireless communication IC 14. Further, the wireless communication module 10 includes an input/output interface circuit 16 and an antenna 18. Further, the wireless communication module 10 includes a DC/DC converter 20 and a security authentication button 22.

The MCU 12 is provided mainly for controlling the wireless communication IC 14. The MCU 12 includes, for example, a wireless communication control CPU 12a, a ROM 12b, and a RAM 12c. The wireless communication control CPU 12a has functions of creating data and performing software processing for communications. The ROM 12b functions as storage means for storing software such as programs. For example, a wireless communication module driver, as software, is stored in advance in the ROM 12b. The wireless communication module driver is software for installing the wireless communication module 10 on the host apparatus 30. Programs or the like, as software, stored in the ROM 12b are loaded in the RAM 12c and executed.

The wireless communication IC 14 is connected to the MCU 12. The wireless communication IC 14 is also connected to the antenna 18 through an SPDT switch (not illustrated). The wireless communication IC 14 is formed of, for example, a radio frequency integrated circuit (RF-IC) or a baseband integrated circuit (BB-IC, baseband IC). The RF-IC has a function of modulating, upon receipt of a baseband signal received from the BB-IC, a carrier wave with this baseband signal, transmitting the modulated carrier wave as an RF signal for the communication with a base station, and, upon receipt of an RF signal from the base station, demodulating the RF signal into a baseband signal and sending the baseband signal to the BB-IC. The BB-IC has a function of sending data to be transmitted to the RF-IC and processing the baseband signal received from the RF-IC as received data.

The input/output interface circuit 16 is provided to control the input/output of data. The input/output interface circuit 16 is connected to the MCU 12 and a USB interface (not illustrated).

The antenna 18 has a function of transmitting/receiving radio waves for realizing the wireless communications with external wireless communication terminals or the like. The antenna 18 is connected to the wireless communication IC 14 through an SPDT switch (not illustrated). As a result of the antenna 18 being provided in the wireless communication module 10, an authentication operation can be performed by the module alone, whereby authentication in one to one correspondence with the host apparatus 30 is not needed.

The DC/DC converter 20 is provided to convert the voltage of a current supplied from a power supply 30b in the host apparatus 30 into a required voltage. The DC/DC converter 20 is connected to the MCU 12 and the wireless communication IC 14. In this manner, since the wireless communication module 10 is provided with the DC/DC converter 20, a voltage as a power supply required in the wireless communication module 10 can be generated using the power supply 30b in the host apparatus 30. Hence, the wireless communication module 10 need not have a power supply dedicated to the wireless communication module 10, resulting in a reduction in the size of the wireless communication module 10.

The security authentication button 22 is provided to facilitate the authentication processing for security at the time when the wireless communication with a wireless communication terminal or the like is realized. A security authentication program, which is software activated by pressing the security authentication button 22, is stored in advance in the ROM 12b or the like in the MCU 12. Note that, by providing a touch panel or the like, the security authentication button 22 like this may be displayed on the touch panel or the like.

The wireless communication module 10 is connected to the host apparatus 30 through, for example, a USB interface (not illustrated). The host apparatus 30 includes a host CPU 30a and a power supply 30b. The host CPU 30a is provided to control the host apparatus 30. When the wireless communication module 10 is connected to the host apparatus 30, the host CPU 30a is connected to the MCU 12. The power supply 30b, which is provided to enable the functions of the host apparatus 30, also plays the role of supplying the power to the wireless communication module 10. As a stand-alone unit, the host apparatus 30 is an apparatus which has no wireless communication means. The host apparatus 30 is, for example, a home appliance, such as a refrigerator, a microwave oven, an air conditioner, or a television, or is an electronic product such as a digital camera. By connecting the wireless communication module 10 to the host apparatus 30, the host apparatus 30 is allowed to perform the wireless communications with external communication terminals or the like. Hence, it becomes possible to remotely control the host apparatus 30 via the wireless communication module 10.

With the wireless communication module 10 according to the present invention, even in the case in which the utilization of the host CPU 30a is high due to the applications being executed in the host apparatus 30, since the MCU 12 on the wireless communication module 10 side executes a program required for wireless communications, a stable throughput can be achieved. Further, with the wireless communication module 10 according to the present invention, since the wireless communication control CPU 12a in the MCU 12 controls the wireless communication IC 14, it is possible to make the functions for wireless communications operable without changing the CPU even in the case in which the processing power of the host CPU 30a in the host apparatus 30 is low or even in the case in which only the host CPU 30a that is not capable of performing the control of wireless communications is mounted in the host apparatus 30. Hence, it is possible to reduce the degree of the decrease in the processing power of the host CPU 30a in the host apparatus 30.

With the wireless communication module 10 according to the present invention, since a wireless communication module driver for the wireless communication module 10 is stored in advance in the ROM 12b of the MCU 12 and is not dependent on the operating system (OS) of the host CPU 30a, it is not necessary to make the host CPU 30a in the host apparatus 30 separately load the wireless communication module driver. Hence, by connecting the wireless communication module 10 to the host apparatus 30, a load for the software integration is reduced when adding a wireless communication function to the host apparatus 30.

Further, since the wireless communication module 10 according to the present invention is provided with the antenna 18, the wireless communication module 10 alone can perform the operation of the wireless authentication. Hence, the authentication in one to one correspondence with the host CPU 30a is not needed, whereby it becomes easy to perform the wireless authentication as a set itself.

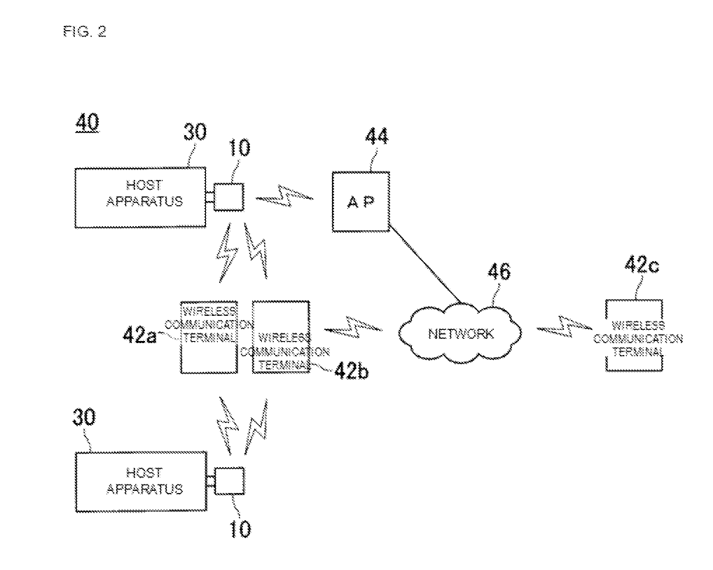

Next, a home network system using the wireless communication module 10 according to the present invention will be described. By connecting the wireless communication module 10 to each of the various apparatuses 30, a home network system can be formed. FIG. 2 is a schematic configuration diagram of a home network system using the wireless communication module according to the present invention. A home network system 40 includes, for example, the wireless communication modules 10, the host apparatuses 30 to which the wireless communication modules 10 are respectively connected, wireless communication terminals 42a, 42b, and 42c, an access point 44, and a network 46.

The wireless communication terminals 42a, 42b, and 42c are terminals that monitor or control the host apparatuses 30 via the wireless communication modules 10. The wireless communication terminals 42a, 42b, and 42c are formed of terminals capable of performing wireless communications, such as PCs and cellular phones. The access point 44 is connected to the wireless communication module 10 through wireless communications. Here, the wireless communication terminals 42a and 42b may be connected to the host apparatuses 30 via the access point 44, thereby performing the control, or the wireless communication terminals 42a and 42b may be directly connected to the wireless communication modules 10. Further, the wireless communication terminal 42c may be connected through the network 46.

By using the home network system 40, the host apparatuses 30 can be monitored by the wireless communication terminals 42a, 42b, and 42c, or the on/off control of the host apparatuses 30 may be performed. Note that a program as software for monitoring or controlling the host apparatuses 30 using the wireless communication terminals 42a, 42b, and 42c is installed in advance in each of the wireless communication terminals 42a, 42b, and 42c.

Here, the wireless communication modules 10 are connected to the wireless communication terminals 42a and 42b through radio waves. The radio waves may be, specifically, those used in wireless LANs, Bluetooth (registered trademark), or ZigBee.

The wireless communication module 10 can easily control the function of enabling the wireless communication with an external terminal of the host apparatus 30 without placing a burden on the host apparatus 30. Hence, by using the wireless communication module 10, the home network system 40 can be easily formed.

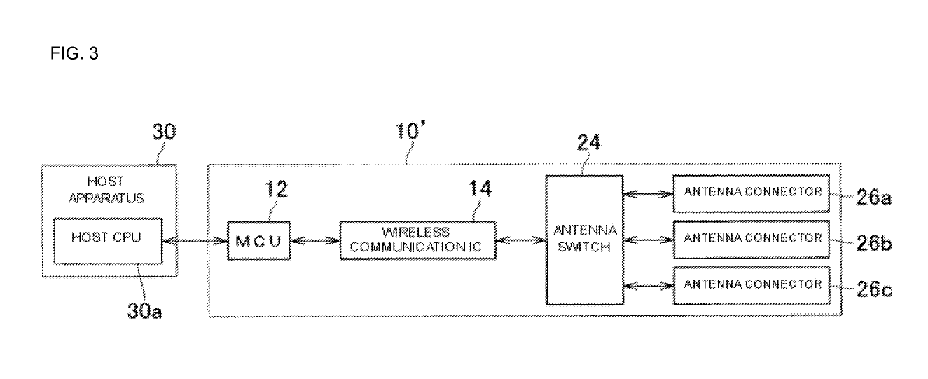

Next, a second embodiment of a wireless communication module according to the present invention will be described. FIG. 3 is a schematic diagram of the second embodiment of a wireless communication module according to the present invention.

A wireless communication module 10′ illustrated in FIG. 3 includes an MCU 12 and a wireless communication IC 14. Further, the wireless communication module 10′ includes an antenna switch 24 and antenna connectors 26a, 26b, and 26c. Note that when compared with FIG. 1, the input/output interface circuit 16, the antenna 18, the DC/DC converter 20, and the security authentication button 22 are omitted in the wireless communication module 10′ illustrated in FIG. 3 and hence, they are not illustrated. The configuration of the MCU 12 illustrated in FIG. 3 is similar to that of the MCU 12 illustrated in FIG. 1.

The antenna switch 24 has a function of selecting one of a plurality of antennas (not illustrated) connected to the antenna connectors 26a, 26b, and 26c. The selection performed by the antenna switch 24 is controlled by the MCU 12. A control program that is software for this antenna selection is stored in advance, for example, in the ROM 12b within the MCU 12. The antenna switch 24 connects the wireless communication IC 14 in the wireless communication module 10′ to one of the antenna connectors 26a, 26b, and 26c used for transmission and reception. Hence, the wireless communication module 10′ is configured in such a manner that the antenna connectors 26a, 26b, and 26c are provided so as to be connectable to the respective plurality of antennas.

With the wireless communication module 10′ according to the present embodiment, since the wireless communication module 10′ can is configured to be connectable to a plurality of antennas through the antenna connectors 26a, 26b, and 26c, an antenna in an appropriate environment for performing the transmission/reception processing is selected by the antenna switch 24 from among the plurality of antennas connected to the antenna connectors, thereby enabling the data transmission/reception in a better environment.

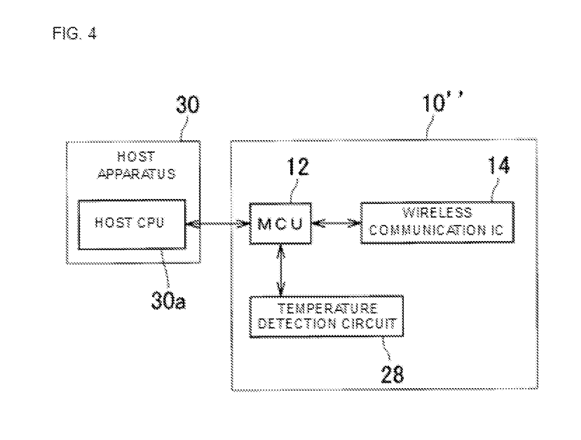

Next, a third embodiment of the wireless communication module according to the present invention will be described. FIG. 4 is a schematic diagram of the third embodiment of the wireless communication module according to the present invention.

A wireless communication module 10″ illustrated in FIG. 4 includes an MCU 12 and a wireless communication IC 14. Further, the wireless communication module 10″ includes a temperature detection circuit 28. The temperature detection circuit 28 is formed of a thermistor, an infrared sensor, or the like. Note that, similarly to the second embodiment, the input/output interface circuit 16, the antenna 18, the DC/DC converter 20, and the security authentication button 22 are omitted in the wireless communication module 10″ illustrated in FIG. 4, compared with FIG. 1, and, hence, they are not illustrated. The configuration of the MCU 12 illustrated in FIG. 4 is similar to that of the MCU 12 illustrated in FIG. 1.

When the temperature of the wireless communication module 10″ is increased to a temperature that will make it difficult to control the wireless communication module 10″ as a result of the amount of the data transmission/reception having increased too much, the temperature detection circuit 28 detects the increased temperature. Then, the temperature information data is sent to the MCU 12 from the temperature detection circuit 28. Then, the MCU 12, which has received the temperature information data, performs control in such a manner that the transmission/reception state in the wireless communication IC 14 is stopped. The control performed by the MCU 12 at this time may be performed in such a manner that the wireless communication module 10″ is controlled so as to enter an idle state, cut off its connection, or inset a delay between transmission packets.

Alternatively, by processing the temperature information data obtained by a temperature sensor (not illustrated) provided in the host apparatus 30 using the temperature detection circuit 28 of the wireless communication module 10″, control may be performed by the MCU 12. Examples of the host apparatus 30 which is controlled by the temperature detection circuit 28 include heat generating apparatuses, such as an air conditioner, a refrigerator, and a lighting apparatus.

Note that a control program as software executed by the MCU 12 when the wireless communication module 10″ receives the temperature information data detected by the temperature detection circuit 28 or a temperature sensor provided in the host apparatus 30 is stored in advance in the ROM 12b within the MCU 12.

With the wireless communication module 10″ according to the present embodiment, it is possible to control the operation of the wireless communication module 10″ and also to monitor the heating state of the host apparatus 30, which is, for example, a home appliance, on the basis of the temperature information data detected by the temperature detection circuit 28 or a temperature detector provided in the host apparatus 30.

Note that the wireless communication module 10 according to the present embodiment includes the antenna 18. However, the wireless communication module 10 is not limited to this configuration, and the wireless communication module 10 needs not include the antenna 18.

Further, the wireless communication module 10 according to the present embodiment includes the DC/DC converter 20. However, the wireless communication module 10 is not limited to this configuration, and the wireless communication module 10 needs not include the DC/DC converter 20.

Further, the wireless communication module 10 according to the present embodiment includes the security authentication button 22. However, the wireless communication module 10 is not limited to this configuration, and the wireless communication module 10 needs not include the security authentication button 22.

A composite module according to the present invention can be used in an application in which, by connecting the composite module to a host apparatus, such as a home appliance, an electric apparatus, or the like, the host apparatus is made to be capable of performing the wireless communications, based on, for example, a wireless LAN, Bluetooth (registered trade mark), and ZigBee.

10, 10′, 10″ wireless communication modules

12 MCU

12a wireless communication control CPU

12b ROM

12c RAM

14 wireless communication IC

16 input/output interface circuit

18 antenna

20 DC/DC converter

22 security authentication button

24 antenna switch

26a, 26b, 26c antenna connectors

28 temperature detection circuit

30 host apparatus

30a host CPU

30b power supply

40 home network system

42a, 42b, 42c wireless communication terminals

44 access point

46 network

1. A composite module connected to a host apparatus and configured to control a function of wireless communications between the host apparatus and an external terminal of the host apparatus, the composite module comprising:
a wireless communication IC;
a storage unit connected to the wireless communication IC and configured to store a composite module driver for installing the composite module on the host apparatus; and
a wireless communication control CPU connected to the wireless communication IC and configured to control the wireless communication IC and process the composite module driver.

2. The composite module according to claim 1,
wherein the host apparatus is a home appliance including a host CPU, and
wherein the wireless communication control CPU is connected to the host CPU and the home appliance performs a function of wireless communications with an external terminal.

3. The composite module according to claim 2, further comprising:
a temperature detection circuit,
wherein the temperature detection circuit is connected to the wireless communication control CPU.

4. The composite module according to claim 1,
wherein the host apparatus includes a power supply, and
wherein the composite module further comprises a DC/DC converter connected to the power supply by connecting the composite module to the host apparatus.

5. The composite module according to claim 2,
wherein the host apparatus includes a power supply, and
wherein the composite module further comprises a DC/DC converter connected to the power supply by connecting the composite module to the host apparatus.

6. The composite module according to claim 3,
wherein the host apparatus includes a power supply, and
wherein the composite module further comprises a DC/DC converter connected to the power supply by connecting the composite module to the host apparatus.
